(19) United States
(12) Patent Application Publication
(10) Pub. No.: US 2014/0211046 A1
(43) Pub. Date: Jul. 31, 2014

(54) Apparatus and Method for Processing Digital Image

(71) Applicant: Samsung Electronics Co., Ltd., Suwon-si (KR)

(72) Inventors: Won-seok Song, Anyang-si (KR); Kyung-min Kim, Seongnam-si (KR)

(73) Assignee: Samsung Electronics Co., Ltd., Suwon-si (KR)

(21) Appl. No.: 14/229,560

(22) Filed: Mar. 28, 2014

Related U.S. Application Data
(62) Division of application No. 12/831,397, filed on Jul. 7, 2010.

(30) Foreign Application Priority Data
Jul. 7, 2009 (KR) 10-2009-0061720

(51) Int. Cl. H04N 5/232

(52) U.S. Cl. CPC H04N 5/23296
USPC 348/240.2

(57) ABSTRACT

An apparatus and method for processing a digital image that allow a user to selectively set a composition in an image by setting a selected location and a selected size of an image of a subject to be photographed in advance. The apparatus for processing a digital image includes a digital signal processor, wherein the digital signal processor sets the selected location and the selected size of an image of a subject to be photographed, zooms corresponding to the set selected size, and induces a composition change corresponding to the set selected location. An optimal image is obtained by enabling selective composition change in an image by a user by setting location and size of an image of a subject to be photographed in advance.

### CROSS-REFERENCE TO RELATED PATENT APPLICATIONS

This application is a divisional of U.S. patent application Ser. No. 12/831,397 filed on Jul. 7, 2010, which claims the benefit of Korean Patent Application No. 10-2009-0061720 filed on Jul. 7, 2009, in the Korean Intellectual Property Office, the disclosures of which are incorporated herein in their entirety by reference.

### BACKGROUND

Various embodiments of the invention relate to an apparatus and method for processing a digital image, that allow a user to selectively set an image composition by setting a desired location and desired size of an image of a subject to be photographed in advance.

In the related art, apparatuses for processing a digital image in which the image data of a subject is stored in various recording media are widely used in our daily life, because a user may easily obtain excellent image thanks to various convenient apparatus functions such as an auto focus control (AF) function, an auto exposure (AE) function, an auto white balance (AWB) function, and auto setting control functions for automatically setting appropriate shutter speed, focus, and white balance according to a scene to be photographed. However, apparatuses for processing a digital image do not directly provide an optimal composition. To obtain a good image composition is difficult for ordinary people who are not specialists. In addition, although the image composition of an image can be changed using an editing function, the changed composition may not be optimal.

### SUMMARY

Various embodiments of the invention provide an apparatus and method for processing a digital image, capable of setting a desired location and desired size of an image of a subject in advance, and capable of changing an image composition according to the desired location and desired size to obtain an optimal image.

According to one embodiment of the invention, an apparatus for processing a digital image is provided, wherein the apparatus includes a digital signal processor, wherein the digital signal processor sets a selected location and a selected size of an image of a subject to be photographed, zooms according to the set selected size, and induces a composition change according to the set selected location.

The digital signal processor provides guide lines that divide a screen into a plurality of portions and the image of the subject is located around at least one of the intersections of the guide lines.

The digital signal processor includes: a composition setting unit for setting the selected location and the selected size of the subject image on the screen that displays the guide lines; a zooming unit for zooming corresponding to the set selected size; and a composition change induction unit for inducing a composition change corresponding to the set selected location.

When the subject is a human, the apparatus and method may further include a facial recognition unit for recognizing the face of the subject.

The composition change induction unit outputs an identification symbol signal, an audio signal, or a video signal for the composition change.

According to another embodiment of the invention, an apparatus for processing a digital image is provided, wherein the apparatus may include a digital signal processor, wherein the digital signal processor sets a selected location and a selected size of an image of a subject to be photographed, zooms according to the set selected size, induces a first composition change according to the set location, and induces a second composition change to induce the image of the subject to be horizontally and vertically balanced.

The digital signal processor provides guide lines that divide a screen into a plurality of portions and the subject image is located around at least one of intersections of the guide lines.

The digital signal processor may include: a composition setting unit for setting the selected location and the selected size of the subject image on a screen that displays the guide lines; a zooming unit for zooming corresponding to the set selected size; an inclination detection unit for detecting a degree of inclination of the image of the subject; and a composition change induction unit for inducing a first composition change corresponding to the set selected location and inducing a second composition change to induce the image of the subject to be horizontally and vertically balanced.

According to another embodiment of the invention, an apparatus for processing a digital image is provided, wherein the apparatus includes a digital signal processor, wherein the digital signal processor sets a selected location and a selected size of an image of a subject to be photographed, zooms corresponding to the set selected size, induces a first composition change corresponding to the set location, and induces a second composition change when there is an edge passing through the image of the subject.

The digital signal processor may provide guide lines that divide a screen into a plurality of portions and the image of subject is located around at least one of the intersections of the guide lines.

The digital signal processor includes: a composition setting unit for setting the selected location and the selected size of the subject on the screen that displays the guide lines; a zooming unit for zooming corresponding to the set selected size; an edge extraction unit for extracting edge information from the screen; and a composition change induction unit for inducing a first composition change corresponding to the set location and, inducing a second composition change when there is an edge that passes through the image of the subject.

According to another embodiment of the invention, an apparatus for processing a digital image is provided, wherein the apparatus includes a digital signal processor, wherein the digital signal processor sets a selected location and a selected size of an image of a subject to be photographed, zooms corresponding to the set selected size, induces a first composition change corresponding to the set selected location, induces a second composition change to make the image of the subject horizontally and vertically balanced, and induces a third composition change when there is an edge passing through the image of the subject.

The digital signal processor may provide guide lines that divide a screen into a plurality of portions and the image of the subject is located around at least one of intersections of the guide lines.

The digital signal processor may include: a composition setting unit for setting the selected location and the size of the image of the subject on the screen that displays the guide lines; a zooming unit for zooming corresponding to the set selected size; an inclination detection unit for detecting a degree of inclination of the subject image; an edge extraction unit for extracting edge information from the screen; and a composition change induction unit for inducing a first composition change corresponding to the set selected location, inducing a second composition change to induce the image of the subject to be horizontally and vertically balanced, and inducing a third composition change when there is an edge passing through the image of the subject.

According to another embodiment of the invention, a method of processing a digital image is provided, wherein the method includes: setting a selected location and a selected size of the image of the subject to be photographed; zooming corresponding to the set selected size; and inducing a composition change corresponding to the set selected location.

The method may further include providing guide lines that divide a screen into a plurality of portions, wherein the image of the subject is located around intersections of the guide lines.

According to another embodiment of the invention, a method of processing a digital image is provided, wherein the method includes: setting a selected location and a selected size of the image of the subject to be photographed; zooming corresponding to the set selected size; inducing a first composition change corresponding to the set selected location; detecting a degree of inclination of the image of the subject; and inducing a second composition change to induce the image of the subject to be horizontally and vertically balanced.

According to another embodiment of the invention, a method of processing a digital image is provided, wherein the method includes: setting a selected location and a selected size of the image of the subject to be photographed; zooming corresponding to the set selected size; inducing a first composition change corresponding to the set selected location; detecting a degree of inclination of the image of the subject; extracting edge information from an image to be captured; and inducing a second composition change when there is an edge passing through the image of the subject.

According to another embodiment of the invention, a method of processing a digital image is provided, wherein the method includes: setting a selected location and a selected size of the image of the subject to be photographed; zooming corresponding to the set selected size; inducing a first composition change corresponding to the set selected location; detecting a degree of inclination of the image of the subject; inducing a second composition change to induce the image of the subject to be horizontally and vertically balanced; extracting edge information from an image to be captured; and inducing a third composition change when there is an edge passing through the image of the subject.

### BRIEF DESCRIPTION OF THE DRAWINGS

The above and other features and advantages of the present invention will become more apparent by describing in detail the exemplary embodiments thereof with reference to the attached drawings.

FIG. 1 is a block diagram of an apparatus for processing a digital image, according to an embodiment of the present invention;

FIG. 2 is a detailed block diagram of an example of a digital signal processor included in the apparatus of FIG. 1;

FIG. 3 is a detailed block diagram of another example of the digital signal processor included in the apparatus of FIG. 1;

FIG. 4 is a detailed block diagram of another example of the digital signal processor included in the apparatus of FIG. 1;

FIG. 5 is a detailed block diagram of another example of the digital signal processor included in the apparatus of FIG. 1;

FIG. 6 illustrates compositions of a live view image set by using the apparatus of FIG. 1;

FIG. 7 illustrates compositions obtained by zooming and performing a composition change according to one of the compositions set in FIG. 6;

FIG. 8 illustrates compositions obtained by performing inclination detection and a composition change according to one of the compositions set in FIG. 6;

FIG. 9 illustrates compositions obtained by performing edge extraction and a composition change according to one of the compositions set in FIG. 6;

FIG. 10 is a flowchart illustrating a method of processing a digital image according to an embodiment of the present invention;

FIG. 11 is a flowchart illustrating a method of processing a digital image according to another embodiment of the present invention;

FIG. 12 is a flowchart illustrating a method of processing a digital image according to another embodiment of the present invention; and

FIG. 13 is a flowchart illustrating a method of processing a digital image according to another embodiment of the present invention.

### DETAILED DESCRIPTION OF THE EMBODIMENTS

Hereinafter, the various embodiments of the invention will be descried in detail with reference to the attached drawings.

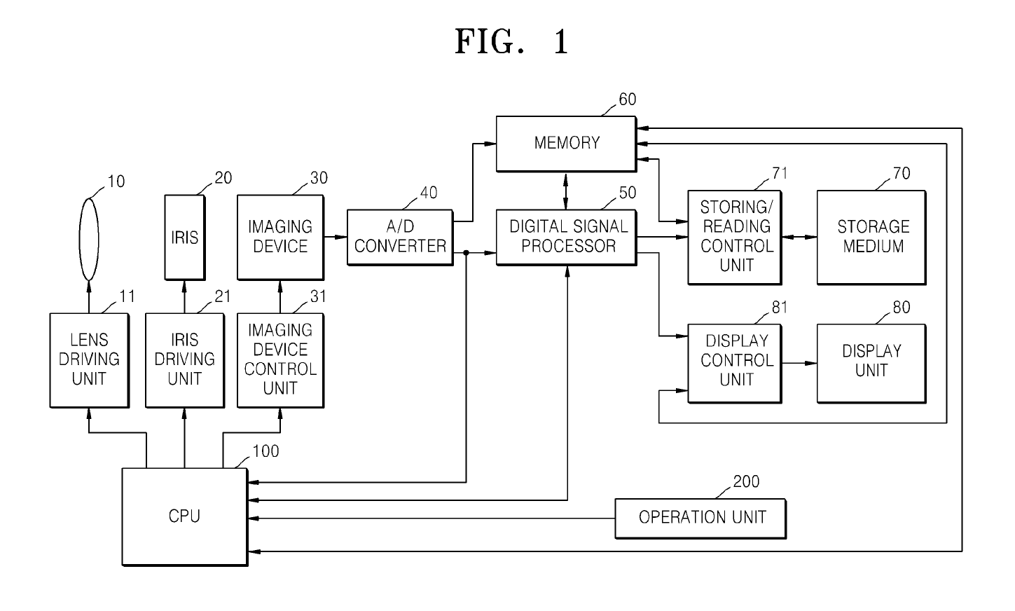

FIG. 1 is a block diagram of an example of an apparatus for processing a digital image, according to an embodiment of the present invention. The present invention, however, is not limited to the apparatus for processing a digital image illustrated in FIG. 1 and may be applied to an apparatus for processing an image, such as personal digital assistants (PDAs) or personal multimedia players (PMP) for processing an image.

The overall operation of the apparatus for processing a digital image is controlled by a central processing unit (CPU) 100. The apparatus for processing a digital image includes an operation unit 200 including, for example, a key that generates an electrical signal according to a user's input. The electrical signal generated by the operation unit 200 is transmitted to the CPU 100 and the CPU 100 controls the apparatus for processing a digital image according to the transmitted electrical signal.

In a shooting mode, when an electrical signal is applied to the CPU 100 according to a user's input, the CPU 100 identifies the electrical signal and controls a lens driving unit 11, an iris driving unit 21, and an imaging device control unit 31. Thus, location of a lens 10, aperture rate of an iris 20, and sensitivity of an imaging device 30 are controlled. The imaging device 30 generates data corresponding to the light received, and an analog-to-digital converter 40 converts the analog data output by the imaging device 30 into digital data. In other embodiments, according to characteristics of the imaging device 30, the analog-to-digital converter 40 may be not used.

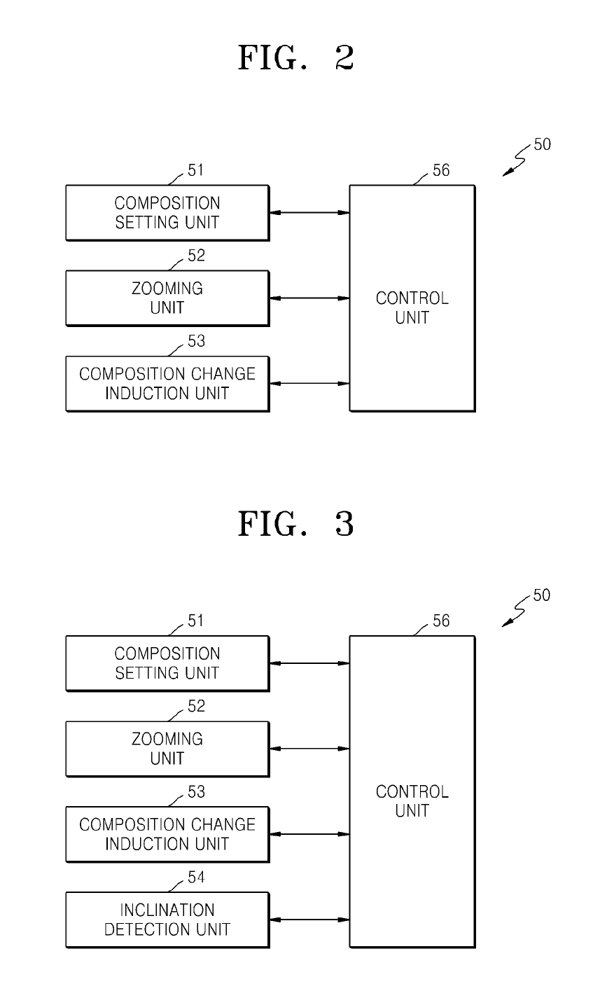

The data generated by the imaging device 30 may be input into a digital signal processor 50 through a memory 60, or may be directly input into the digital signal processor 50, or may be input into the CPU 100. The memory 60 may include a ROM or RAM. If needed, the digital signal processor 50 may perform a digital signal process such as gamma correction or white balance change. Also, as illustrated in FIGS. 2 through 5, the digital signal processor 50 may include a composition setting unit 51, a zooming unit 52, a composition change induction unit 53, an inclination detection unit 54, an edge extraction unit 55, and a control unit 56. However, any of the composition setting unit 51, the zooming unit 52, the composition change induction unit 53, the inclination detection unit 54, the edge extraction unit 55, and the control unit 56 may be not included in the digital signal processor 50. That is, any of the composition setting unit 51, the zooming unit 52, the composition change induction unit 53, the inclination detection unit 54, the edge extraction unit 55 may exist as independent elements in the apparatus for processing a digital image. In other words, the composition setting unit 51, the zooming unit 52, the composition change induction unit 53, the inclination detection unit 54, the edge extraction unit 55, and the control unit 56 may be included in various locations in the apparatus for processing a digital image. Operations of the composition setting unit 51, the zooming unit 52, the composition change induction unit 53, the inclination detection unit 54, the edge extraction unit 55, and the control unit 56 will be described later.

Data output by the digital signal processor 50 corresponding to an image may be transferred to a display control unit 81 through the memory 60, or may be directly transferred to the display control unit 81. The display control unit 81 controls a display unit 80 and displays the image on the display unit 80. According to an embodiment of the present invention, the display unit 80 may be a touch screen. The data output by the digital signal processor 50 may be input into a storing/reading control unit 71 through the memory 60, or may be directly input into a storing/reading control unit 71. The storing/reading control unit 71 may store image data in a storage medium 70 according to a signal input by a user or automatically. Also, the storing/reading control unit 71 may read data of an image file stored in the storage medium 70, and input the data into the display control unit 81 through the memory 60 or other pathways to display an image on the display unit 80. The storage medium 70 may be separable or permanently installed in the apparatus for processing a digital image.

Hereinafter, function of the digital signal processor 50 will be described with reference to FIGS. 2 through 10.

FIG. 2 is a detailed block diagram of an example of the digital signal processor 50. The digital signal processor 50 sets a desired location and a desired size of an image of a subject to be photographed in a live view image, zooms according to the set desired size, and induces composition change according to the set desired location. To do this, the digital signal processor 50 may include the composition setting unit 51, the zooming unit 52, the composition change induction unit 53, and the control unit 56.

The composition setting unit 51 receives signals corresponding to the desired location and desired size of the image of the subject set in a live view image displayed on the display unit 80 by a user. The composition setting unit 51 provides guide lines to help a user set the desired location and desired size of the subject image. In one embodiment, the guide lines may divide a screen of the display unit 80 into 9 portions. This division is used to help position the image of the subject around at least one of four intersections formed by dividing the screen of the display unit 80 into 9 portions. If the image of the subject is positioned around at least one of the four intersections, an optimal composition is obtained.

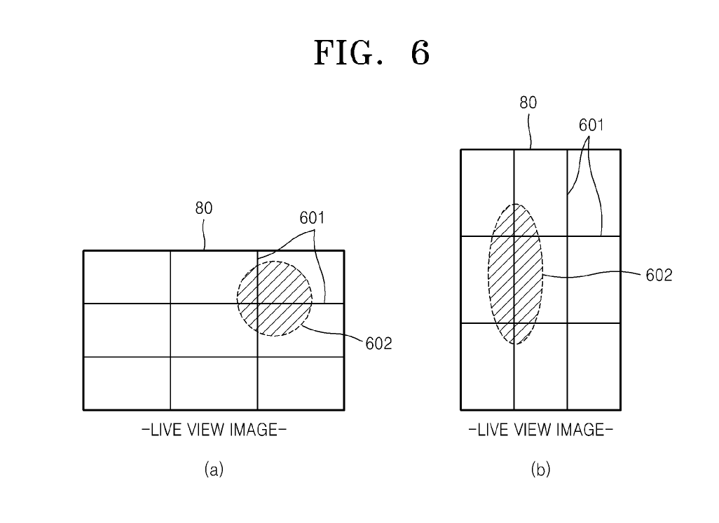

FIGS. 6(a) and 6(b) illustrate guide lines 601 that divide a live view image into 9 portions and a mask region 602 for setting the size of the image of the subject. The mask region 602 may cover a portion of the subject or may cover the entire subject. If the display unit 80 is a touch screen, the size of the mask region 602 is set by a user's touch, and if the display unit 80 is not a touch screen, the size of the mask region 602 is set by using the operation unit 200, wherein the size of the mask region 602 corresponds to the desired size of the subject image.

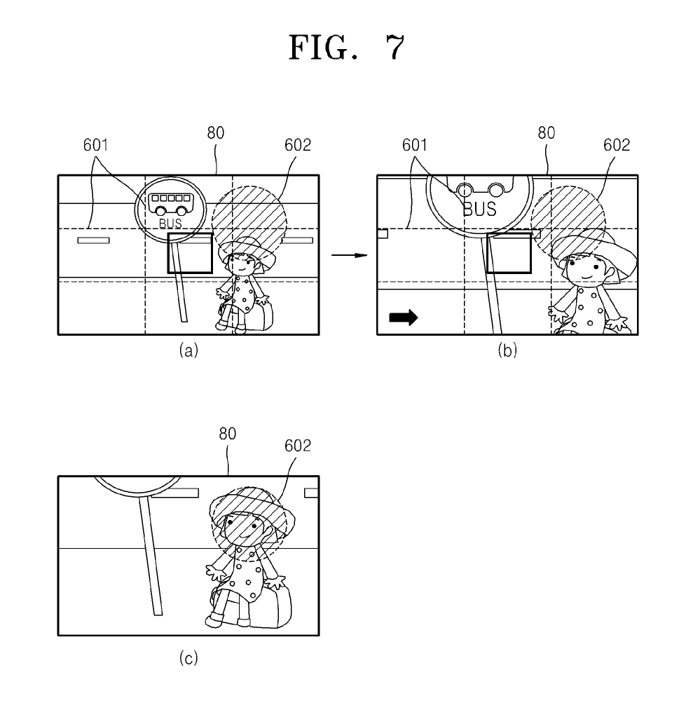

In FIG. 7(a), the desired location and desired size of an image of a subject are set by referring to the guide lines 601 displayed on a live view image, according to an embodiment of the present invention.

The control unit 56 receives signals corresponding to the desired location and desired size of the subject image set in the composition setting unit 51, compares the set desired size of the mask region 602 to the actual size of the image of the subject, and outputs a zoom control signal for zooming in such a way that the actual size of the subject image matches the size of the mask region 602.

For example, if the mask region 602 is to correspond to the face of a subject, the control unit 56 performs facial recognition and compares the actual size of the recognized facial image with the size of the mask region 602. According to the comparison result, the control unit 56 outputs a zoom control signal for zooming such that the actual size of the recognized facial image matches the size of the mask region 602.

The zooming unit 52 receives the zoom control signal from the control unit 56 and automatically zooms the live view image. The automatic zooming may be optical zooming or digital zooming. The image shown in FIG. 7(b) is obtained by zooming in because the size of the mask region 602 set in FIG. 7(a) is larger than the actual size of the image of the subject.

The control unit 56 compares the location of the mask region 602 that has been zoomed with the desired location of the subject image set by the composition setting unit 51, and if the locations are different from each other, outputs a composition change control signal to match the location of the mask region 602 with the desired location of the subject image set by the composition setting unit 51.

The composition change induction unit 53 receives the composition change control signal from the control unit 56, and outputs a signal for a user to induce a composition change. For a user to induce a composition change, the composition change induction unit 53 may output an identification symbol (for example, an arrow), an audio signal (speaking out, for example, “move right” or “move left”'), or video signal (for example, an image displaying a camera moving left to right).

FIG. 7(b) illustrates an example of an identification symbol (arrow) as a composition change induction signal when the location of the zoomed subject image is different from the set location, and FIG. 7(c) illustrates the result obtained by performing composition change according to the composition change induction signal.

The control unit 56 outputs the composition change control signal until the location of the subject image in the changed composition matches the set location of the subject image. When the location of the subject image in the changed composition matches the set location of the subject, the control unit 56 controls photographing.

FIG. 3 is a detailed block diagram of another example of the digital signal processor 50. The digital signal processor 50 sets a desired location and a desired size of an image of a subject to be photographed in a live view image, zooms according to the set desired size, induces a first composition change according to the set desired location, and induces a second composition change such that the image of the subject is horizontally and vertically balanced. To do this, the digital signal processor 50 may include the composition setting unit 51, the zooming unit 52, the composition change induction unit 53, the inclination detection unit 54, and the control unit 56.

The composition setting unit 51 receives signals corresponding to the desired location and desired size of the image of the subject set in a live view image displayed on the display unit 80 by a user. As described in the previous embodiments, the composition setting unit 51 provides the guide lines 601 for setting the desired location of the subject image, and the mask region 602 for setting the desired size of the subject image.

The control unit 56 receives signals corresponding to the desired location and desired size of the subject image set in the composition setting unit 51, compares the set desired size of the mask region 602 to the actual size of the subject image, and outputs a zoom control signal for zooming such that the actual size of the subject image matches the size of the mask region 602.

The zooming unit 52 receives the zoom control signal from the control unit 56 and automatically zooms the live view image.

The control unit 56 compares the location of the image of the subject that has been zoomed with the desired location of the image of the subject set by the composition setting unit 51, and if the locations are different from each other, the control unit 56 outputs a first composition change control signal to match the location of the mask region 602 with the desired location of the subject image set by the composition setting unit 51.

The composition change induction unit 53 receives the first composition change control signal from the control unit 56, and outputs a signal (for example, an identification symbol, an audio signal, or a video signal) for a user to induce composition change.

The inclination detection unit 54 evaluates an inclination degree of the image of the subject by referring to the guide lines 601. The inclination detection unit 54 may use an acceleration sensor (not shown) or a gyro sensor (not shown) to detect the inclination degree of the subject image.

The control unit 56 receives a signal corresponding to the inclination degree from the inclination detection unit 54, and outputs the second composition change control signal to induce the image of the subject to be horizontally and vertically balanced.

The composition change induction unit 53 receives the second composition change control signal from the control unit 56, and outputs a signal (for example, an identification symbol, an audio signal, or a video signal) for a user to induce composition change.

The control unit 56 outputs the first and second composition change control signals until the location of the subject image in the changed composition matches the set desired location of the subject image and the subject image is horizontally and vertically balanced. When the location of the subject image in the changed composition matches the set desired location of the subject image and the subject image is horizontally and vertically balanced, the control unit 56 controls photographing.

In this example, the composition change with respect to the desired size and desired location of the image of the subject is induced and then the composition change with respect to making the subject image horizontally and vertically balanced is induced. In other cases, however, the composition change with respect to the desired size and desired location of the subject image can be induced after the composition change with respect to making the image of the subject horizontally and vertically balanced has been induced.

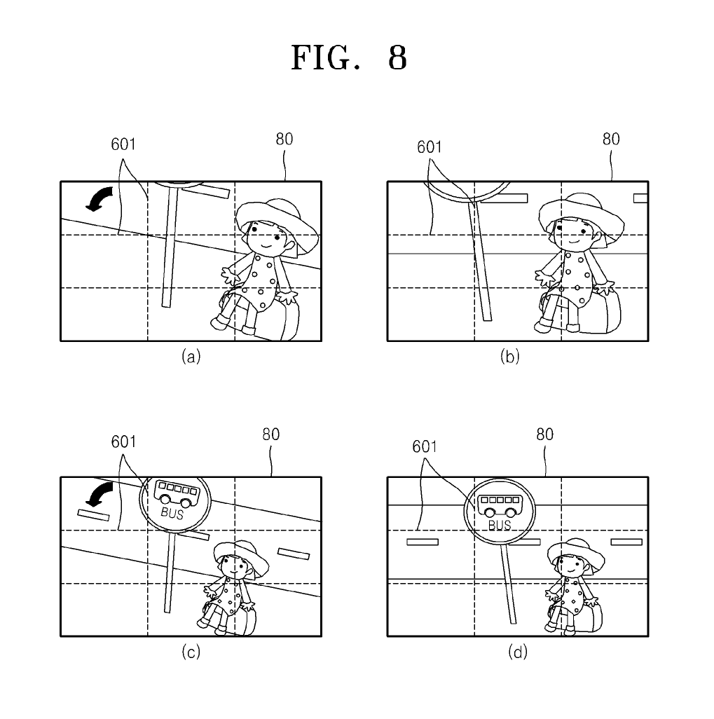

FIG. 8(a) illustrates an example in which an inclination is detected in the zoomed live view image and thus an identification symbol (arrow) as a second composition change induction signal is displayed, and FIG. 8(b) illustrates the image of the subject whose orientation has been rotated according to the second composition change induction signal. FIG. 8(c) illustrates an example in which, before the desired size and desired location of the subject are set, an inclination is detected in the zoomed live view image and thus an identification symbol (arrow) as the second composition change induction signal is displayed. FIG. 8(d) illustrates the image of the subject whose orientation has been rotated corresponding to the second composition change induction signal.

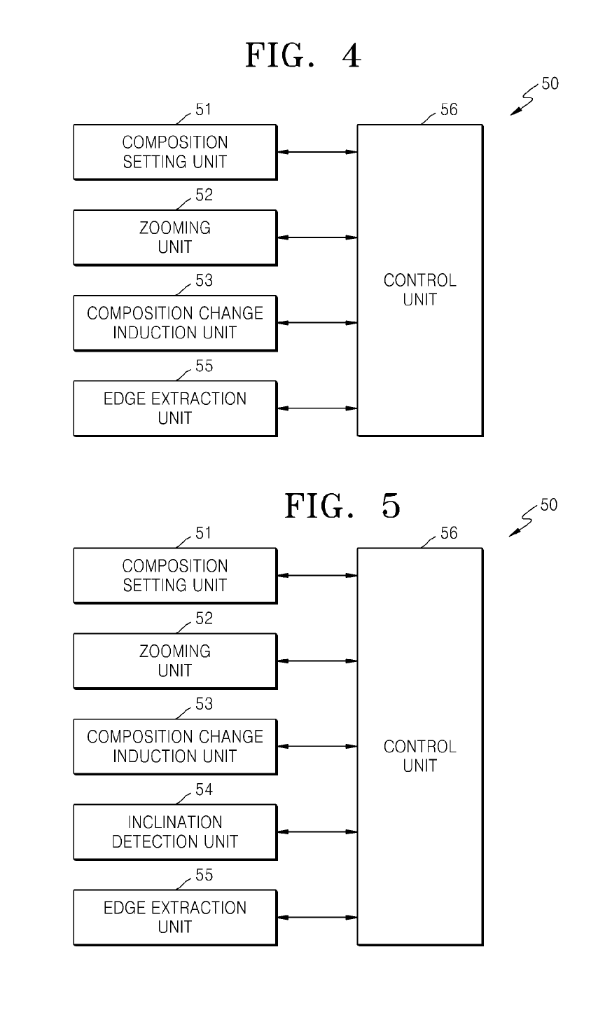

FIG. 4 is a detailed block diagram of another example of the digital signal processor 50. The digital signal processor 50 sets a desired location and a desired size of an image of a subject to be photographed in a live view image, zooms according to the set desired size, induces a first composition change according to the set desired location, and if there is an edge passing through the center of the subject image, induces a second composition change. To do this, the digital signal processor 50 may include the composition setting unit 51, the zooming unit 52, the composition change induction unit 53, the edge extraction unit 55, and the control unit 56.

The composition setting unit 51 and the zooming unit 52 have been described in the two previous examples of the digital signal processor 50 and thus will not be described herein.

The composition change induction unit 53 receives a first composition change control signal from the control unit 56, and outputs a signal (for example, an identification symbol, an audio signal, or a video signal) for a user to induce composition change.

The edge extraction unit 55 extracts edge information from the live view image. The edge extraction unit 55 may use a high-frequency filter (not shown) to extract edge information from the live view image.

The control unit 56 receives edge information from the edge extraction unit 55, and if there is an edge passing through the center of the subject image, the control unit 56 outputs a second composition change control signal to avoid the edge.

The composition change induction unit 53 receives the second composition change control signal from the control unit 56, and outputs a signal (for example, an identification symbol, an audio signal, or a video signal) for a user to induce composition change.

The control unit 56 outputs the first and second composition change control signals until the location of the subject in the changed composition matches the set desired location of the subject and there is no edge passing through the center of the subject image. When the location of the subject image in the changed composition matches the set location of the subject image and there is no edge passing through the center of the subject image, the control unit 56 controls photographing.

In this example, the composition change with respect to the desired size and desired location of the image of the subject is induced and then the composition change for preventing presence of an edge passing through the center of the subject image is induced. In other examples, however, the composition change with respect to the desired size and desired location of the subject image can be induced after the composition change for preventing presence of an edge passing through the center of the subject image has been induced.

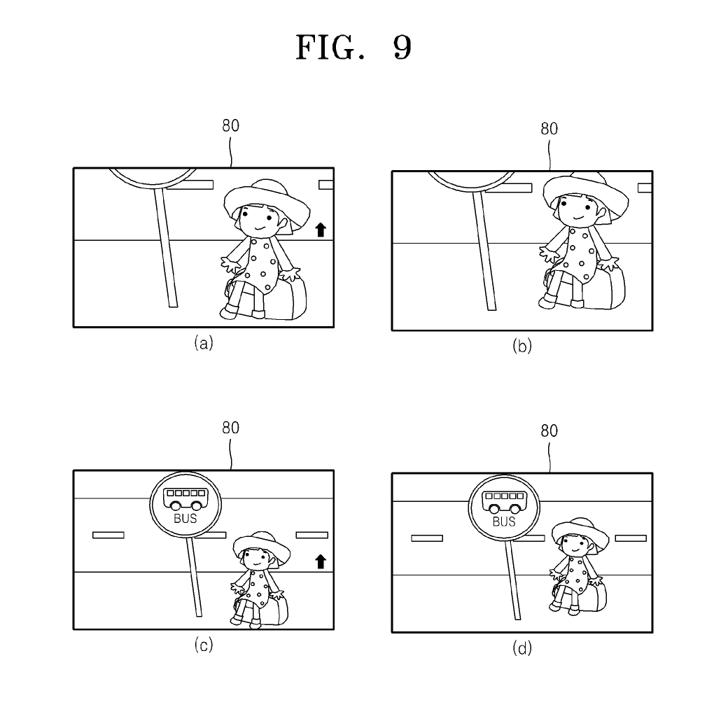

FIG. 9(a) illustrates an example in which an edge is detected through the center of an image of a subject in a zoomed live view image and thus an identification symbol (arrow) as the second composition change induction signal is displayed, and FIG. 9(b) illustrates an example in which there is no edge passing through the center of the subject image after the apparatus is moved according to the second composition change induction signal. FIG. 9(c) illustrates an example in which, before the desired size and desired location of the subject image are set, an edge passing through the center of the subject image is detected in the live view image and thus an identification symbol (arrow) as the second composition change induction signal is displayed, and FIG. 9(d) illustrates an example in which there is no edge passing through the center of the subject image after the apparatus is moved according to the second composition change induction signal.

FIG. 5 is a detailed block diagram of another example of the digital signal processor 50. The digital signal processor 50 sets a desired location and a desired size of an image of a subject to be photographed in a live view image, zooms according to the set desired size, induces a first composition change according to the set desired location, induces a second composition change to induce the subject image to be horizontally and vertically balanced, and, if there is an edge passing through the center of the subject image, induces a third composition change. To do this, the digital signal processor 50 may include the composition setting unit 51, the zooming unit 52, the composition change induction unit 53, the inclination detection unit 54, the edge extraction unit 55, and the control unit 56. The composition setting unit 51, the zooming unit 52, the composition change induction unit 53, the inclination detection unit 54, the edge extraction unit 55, and the control unit 56 all have been described in the three previous examples of the composition setting unit 51 and thus, will not be described herein.

In this example, the composition change with respect to the desired size and desired location of the subject is induced and the composition change for inducing the subject image to be horizontally and vertically balanced is induced, and then the composition change for preventing presence of an edge passing through the center of the subject image is induced. However, the composition change sequence is not limited thereto.

According to another embodiment, as illustrated in FIG. 6, after setting the desired location and desired size of the subject image by using the guide lines 601 and the mask region 602, a user may hand over the apparatus for processing a digital image to others and ask others to take a picture with it. By doing so, others may easily notice the intention of the user and may take a picture accordingly.

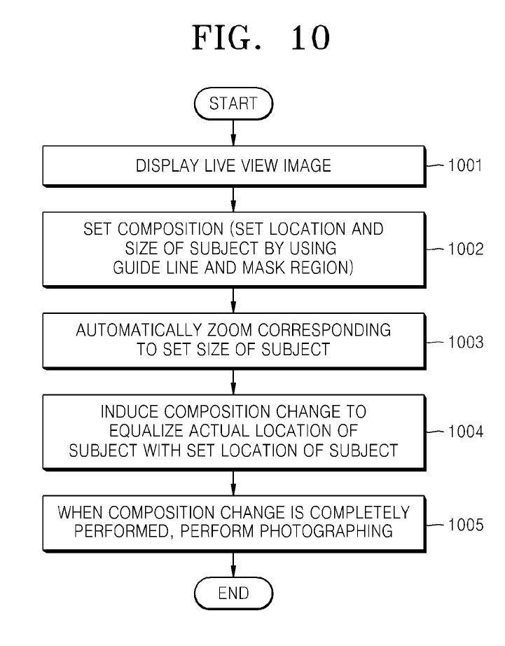

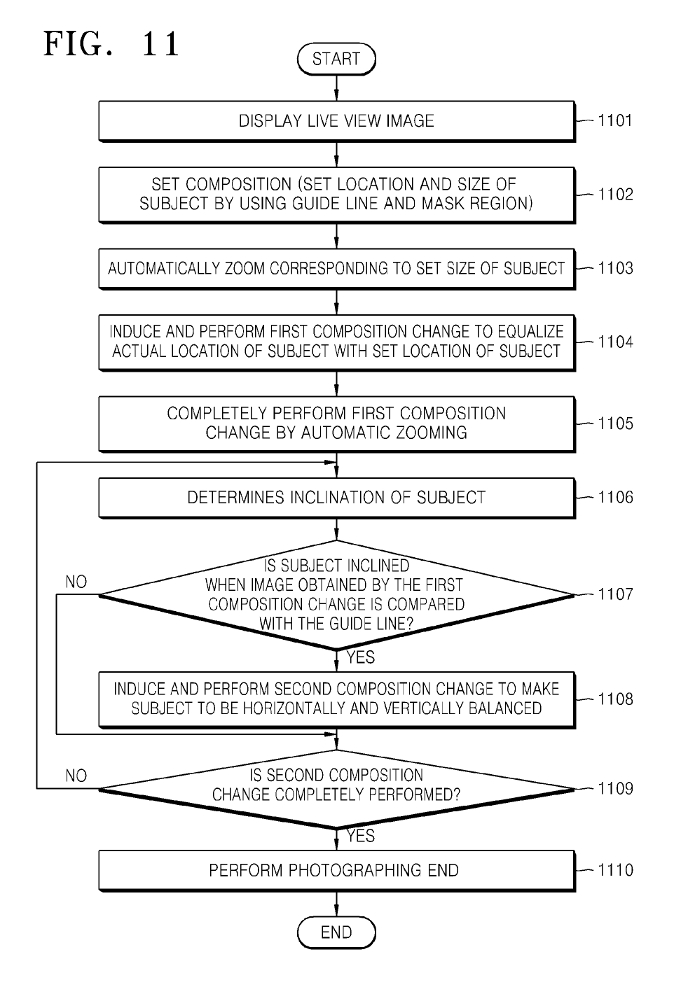

Hereinafter, methods of processing a digital image according to embodiments of the present invention will be described in detail with reference to FIGS. 10 through 13. The method may be performed using the apparatus for processing a digital image illustrated in FIG. 1. Specifically, a major algorithm of the method may be performed using the digital signal processor 50 with support of other surrounding elements.

First, a method of processing a digital image according to an embodiment of the present invention will be described with reference to FIG. 10.

When a user turns on the apparatus for processing a digital image, the digital signal processor 50 displays a live view image on the display unit 80 (operation 1001).

Then, the digital signal processor 50 displays guide lines and a mask region for setting a composition in the live view image, and receives a composition set by the user. A desired location of the subject image may be set around intersections of the guide lines and a desired size of the subject image may be set by using the mask region (operation 1002).

When the setting of the desired location and desired size of the image of the subject has been completely performed, the digital signal processor 50 automatically zooms according to the set desired size of the subject image (operation 1003).

When the automatic zooming has been completely performed, the digital signal processor 50 induces a composition change to match the actual location of the subject image with the set desired location of the subject image (operation 1004).

When the composition change has been completely performed, photographing is performed according to a shooting signal corresponding to a user's input (operation 1005).

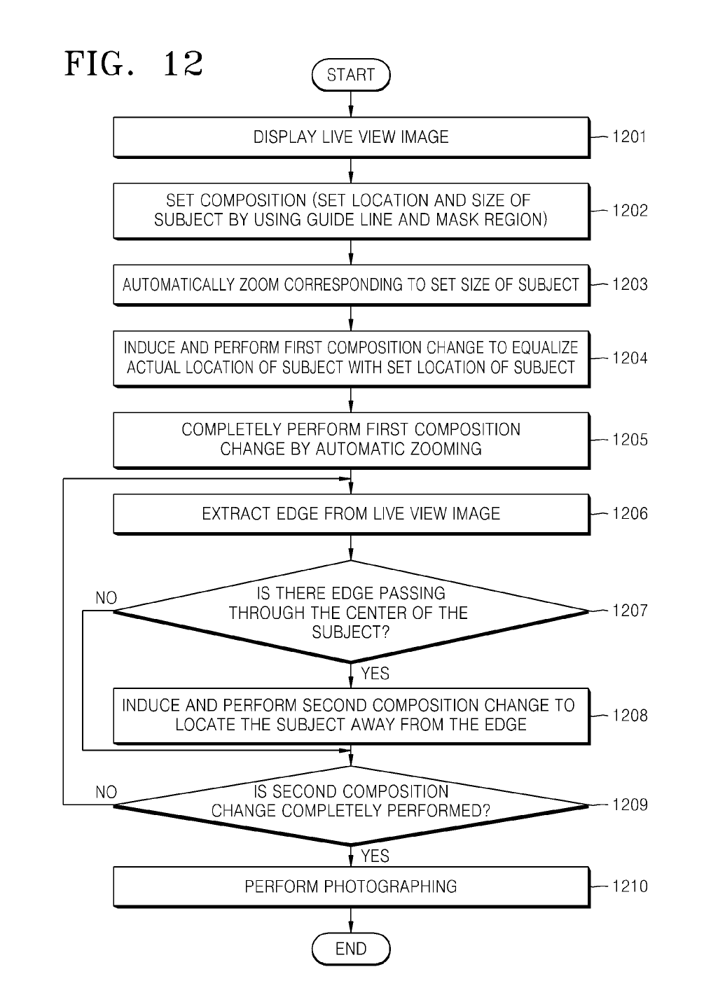

A method of processing a digital image according to another embodiment of the present invention will be described with reference to FIG. 11.

When a user turns on the apparatus for processing a digital image, the digital signal processor 50 displays a live view image on the display unit 80 (operation 1101).

Then, the digital signal processor 50 displays guide lines and a mask region for setting a composition in the live view image and receives a composition set by the user. A desired location of the subject image may be set around the intersections of the guide lines and a desired size of the subject image may be set by using the mask region (operation 1102).

When the setting of the desired location and desired size of the subject has been completely performed, the digital signal processor 50 automatically zooms according to the set desired size of the subject image (operation 1103).

When the automatic zooming has been completely performed, the digital signal processor 50 induces a first composition change to match the actual location of the subject image with the set desired location of the subject image, and the user who perceives the induction performs the first composition change (operation 1104).

Then, the digital signal processor 50 completely performs the first composition change by automatic zooming (operation 1105).

When the first composition change has been completely performed, the digital signal processor 50 determines the inclination of the image of the subject by referring to the guide lines (operation 1106).

The digital signal processor 50 determines whether the image of the subject is inclined when an image obtained by the first composition change is compared with the guide lines, by using an acceleration sensor (not shown) or a gyro sensor (not shown) (operation 1107).

When the subject image is inclined, the digital signal processor 50 induces a second composition change to induce the subject image to be horizontally and vertically balanced when the user compares the resulting image from the first composition change with the guide lines, and the user who perceives the induction performs the second composition change (operation 1108).

When the second composition change has been completely performed (operation 1109), the digital signal processor 50 performs photographing according to a shooting signal corresponding to a user's input (operation 1110).

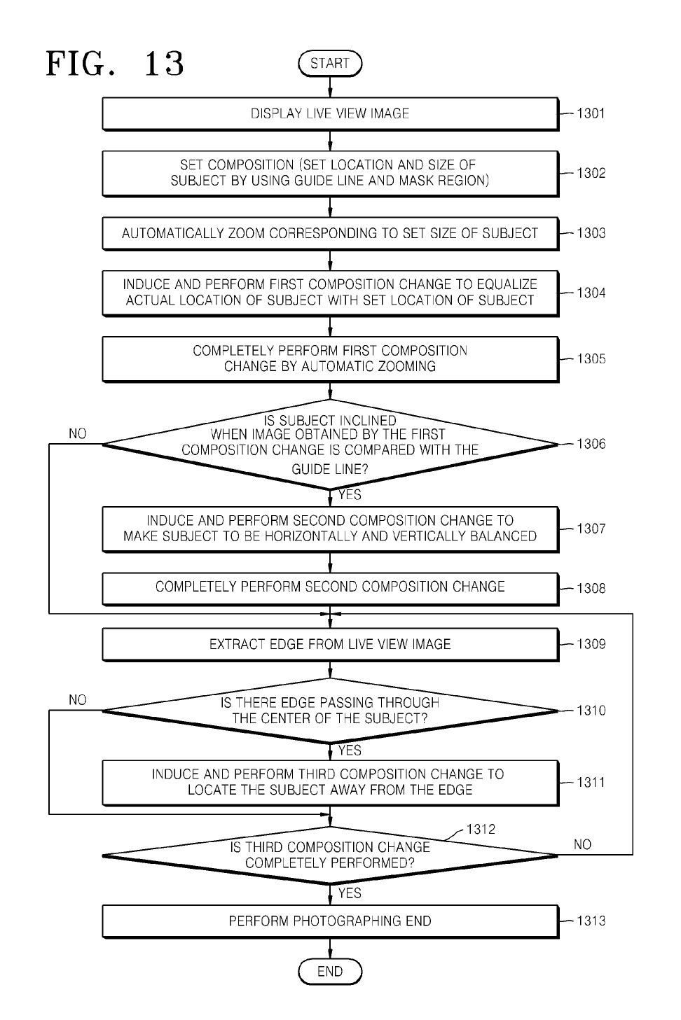

A method of processing a digital image according to another embodiment of the present invention will be described with reference to FIG. 12.

When a user turns on the apparatus for processing a digital image, the digital signal processor 50 displays a live view image on the display unit 80 (operation 1201).

Then, the digital signal processor 50 displays guide lines and a mask region for setting a composition in the live view image and receives a composition set by the user. A desired location of the subject image may be set around intersections of the guide line and a desired size of the subject image may be set by using the mask region (operation 1202).

When the setting of the desired location and desired size of the subject image has been completely performed, the digital signal processor 50 automatically zooms according to the set desired size of the subject image (operation 1203).

When the automatic zooming has been completely performed, the digital signal processor 50 induces a first composition change to match the actual location of the subject image with the set location of the subject image, and the user who perceives the induction performs the first composition change (operation 1204).

Then, the digital signal processor 50 completely performs the first composition change by automatic zooming (operation 1205)

When the first composition change has been completely performed, the digital signal processor 50 extracts edge information from the live view image by using a high-frequency filter (not shown) (operation 1206).

The digital signal processor 50 determines whether an edge passes through the center of the subject image (operation 1207).

When there is an edge passing through the center of the subject image, the digital signal processor 50 induces a second composition change to position the image of the subject away from the edge, and the user who perceives the induction performs the second composition change (operation 1208).

When the second composition change has been completely performed (operation 1209), the digital signal processor 50 performs photographing according to a shooting signal corresponding to a user's input (operation 1210).

A method of processing a digital image according to another embodiment of the present invention will be described with reference to FIG. 13.

When a user turns on the apparatus for processing a digital image, the digital signal processor 50 displays a live view image on the display unit 80 (operation 1301).

Then, the digital signal processor 50 displays guide lines and a mask region for setting a composition in the live view image and receives a composition set by the user. A desired location of the subject image may be set around intersections of the guide lines and a desired size of the subject image may be set by using the mask region (operation 1302).

When the setting of the desired location and desired size of the subject image has been completely performed, the digital signal processor 50 automatically zooms according to the set desired size of the subject image (operation 1303).

When the automatic zooming is completely performed, the digital signal processor 50 induces a first composition change to match the actual location of the subject image with the set desired location of the subject image, and the user who perceives the induction performs the first composition change (operation 1304).

Then, the digital signal processor 50 completely performs the first composition change by automatic zooming (operation 1305).

The digital signal processor 50 determines whether the image of the subject is inclined when an image obtained by the first composition change is compared with the guide lines, by using an acceleration sensor (not shown) or a gyro sensor (not shown) (operation 1306).

When the image of the subject is inclined, the digital signal processor 50 induces a second composition change to induce the subject image to be horizontally and vertically balanced when the user compares the image obtained by the first composition change with the guide lines, and the user who perceives the induction performs the second composition change (operation 1307).

Then, the digital signal processor 50 completely performs the second composition change (operation 1308).

When the second composition change has been completely performed, the digital signal processor 50 extracts edge information from the live view image by using a high-frequency filter (not shown) (operation 1309).

The digital signal processor 50 determines whether an edge passes through the center of the subject image (operation 1310).

When there is the edge passing through the center of the subject image, the digital signal processor 50 induces a third composition change to position the subject image away from the edge, and the user who perceives the induction performs the third composition change (operation 1311).

When the third composition change has been completely performed (operation 1312), the digital signal processor 50 performs photographing according to a shooting signal corresponding to a user's input (operation 1313).

As described in the above embodiments of the invention, a user selectively performs a composition change on an image by setting a desired location and a desired size of an image of a subject to be photographed in advance. Thus, an optimal image is obtained.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical.”

The use of the terms “a” and “an” and “the” and similar referents in the context of describing the invention (especially in the context of the following claims) are to be construed to cover both the singular and the plural. Furthermore, the steps of all methods described herein can be performed in any suitable order unless otherwise indicated herein or otherwise clearly contradicted by context.

Numerous modifications and adaptations will be readily apparent to those skilled in this art without departing from the spirit and scope of the present invention.

What is claimed is:

1. An apparatus for processing a digital image, comprising:
a digital signal processor, wherein the digital signal processor sets a selected location and a selected size of an image of a subject to be photographed, zooms according to the set selected size, induces a first composition change according to the set location, and induces a second composition change to induce the image of the subject to be horizontally and vertically balanced.

2. The apparatus of claim 1, wherein the digital signal processor provides guide lines that divide a screen into a plurality of portions and the image of the subject is located around at least one of the intersections of the guide lines.

3. The apparatus of claim 2, wherein the digital signal processor comprises:
a composition setting unit for setting the selected location and the selected size of the image of the subject on a screen that displays the guide lines;
a zooming unit for zooming corresponding to the set selected size;
an inclination detection unit for detecting a degree of inclination of the image of the subject; and
a composition change induction unit for inducing a first composition change corresponding to the set selected location and inducing a second composition change to induce the image of the subject to be horizontally and vertically balanced.

4. An apparatus for processing a digital image, comprising:
a digital signal processor, wherein the digital signal processor sets a selected location and a selected size of an image of a subject to be photographed, zooms corresponding to the set selected size, induces a first composition change corresponding to the set location, and induces a second composition change when there is an edge passing through the image of the subject.

5. The apparatus of claim 4, wherein the digital signal processor provides guide lines that divide a screen into a plurality of portions and the image of the subject is located around at least one of the intersections of the guide lines.

6. The apparatus of claim 5, wherein the digital signal processor comprises:
a composition setting unit for setting the selected location and the selected size of the image of the subject on the screen that displays the guide lines;
a zooming unit for zooming corresponding to the set selected size;
an edge extraction unit for extracting edge information from the screen; and
a composition change induction unit for inducing a first composition change corresponding to the set location and, inducing a second composition change when there is an edge passing through the image of the subject.

7. An apparatus for processing a digital image, comprising:
a digital signal processor, wherein the digital signal processor sets a selected location and a selected size of an image of a subject to be photographed, zooms corresponding to the set selected size, induces a first composition change corresponding to the set selected location, induces a second composition change to make the image of the subject horizontally and vertically balanced, and induces a third composition change when there is an edge passing through the image of the subject.

8. The apparatus of claim 7, wherein the digital signal processor provides guide lines that divide a screen into a plurality of portions and the image of the subject is located around at least one of the intersections of the guide lines.

9. The apparatus of claim 8, wherein the digital signal processor comprises:
a composition setting unit for setting the selected location and the size of the image of the subject on the screen that displays the guide lines;
a zooming unit for zooming corresponding to the set selected size;
an inclination detection unit for detecting a degree of inclination of the image of the subject;
an edge extraction unit for extracting edge information from the screen; and
a composition change induction unit for inducing a first composition change corresponding to the set selected location, inducing a second composition change to induce the image of the subject to be horizontally and vertically balanced, and inducing a third composition change when there is an edge passing through the image of the subject.

10. A method of processing a digital image, the method comprising:
setting a selected location and a selected size of the image of the subject to be photographed;
zooming corresponding to the set selected size;
inducing a first composition change corresponding to the set selected location;
detecting a degree of inclination of the subject; and
inducing a second composition change to induce the image of the subject to be horizontally and vertically balanced.

11. A method of processing a digital image, the method comprising:
setting a selected location and a selected size of the image of the subject to be photographed;
zooming corresponding to the set selected size;
inducing a first composition change corresponding to the set selected location;
detecting a degree of inclination of the image of the subject;
extracting edge information from an image to be captured; and
inducing a second composition change when there is an edge passing through the image of the subject.

12. A method of processing a digital image, the method comprising:
setting a selected location and a selected size of the image of the subject to be photographed;
zooming corresponding to the set selected size;
inducing a first composition change corresponding to the set selected location;
detecting a degree of inclination of the image of the subject;
inducing a second composition change to induce the image of the subject to be horizontally and vertically balanced;
extracting edge information from an image to be captured; and
inducing a third composition change when there is an edge passing through image of the subject.
